(19) United States
(12) Patent Application Publication
(10) Pub. No.: US 2003/0202186 A1
(43) Pub. Date: Oct. 30, 2003

(54) Method and apparatus for ultra high-resolution interferometry

(75) Inventors: Robert Kai Yiu Chan, Kowloon (CN); Pui Kong Lim, Kowloon (CN)

Correspondence Address: MERCHANT & GOULD PC, 3200 IDS CENTER, 80 SOUTH EIGHTH STREET, MINNEAPOLIS, MN, 55402-0903, US

(73) Assignee: Hong Kong Baptist University, Kowloon (CN)

(21) Appl. No.: 10/131,667

(22) Filed: Apr. 24, 2002

(51) Int. Cl. G01B 9/02

(52) U.S. Cl. 356/451

(57) ABSTRACT

A method and apparatus for high-resolution interferometry and high-resolution spectrometry. The apparatus includes a beam splitter, at least one test path reflector, a fixed reflector mount, a movable reflector mount with at least one test path reflector thereon, a reference return reflector, a test return reflector on either the fixed reflector mount or the movable reflector mount, and a sensor. A beam of light hitting the beam splitter is split into a test beam and a reference beam. The test beam is directed towards the test return reflector via the test path reflectors, then is reflected by the test return reflector back to the beam splitter by the same path. The beam splitter directs part of the test beam to the sensor. The reference beam is directed towards the reference return reflector, which reflects it back to the beam splitter. The beam splitter directs part of the reference beam to the sensor. At the sensor, the test and reference beams interfere. Because the test beam reflects back and forth between the movable reflector mount and the fixed reflector mount at least twice, moving the movable reflector mount changes the length of the test beam optical path by at least twice the distance of the movement. The interference pattern at the sensor thus varies at least twice as rapidly it otherwise would. As a result, the resolution of the interferometer, or a spectrometer of which it is a part, is twice what it otherwise would be.

### BACKGROUND OF THE INVENTION

The invention relates to an apparatus and method for high-resolution interferometry. The invention also relates to an apparatus and method for spectrometry using high-resolution interferometry.

The physical phenomenon of wave interference is well known. Wave interference occurs when two or more waves are combined. In such an event, the intensity of each wave sums together to produce a distinguishable pattern. The pattern typically varies in time, space, or both.

One widely known example of wave interference is the so-called “beat frequency” that can be observed when two musical tones with slightly different frequencies are played together. Since the two tones have slightly different frequencies, the relationship between their respective maxima and minima varies over time. When the maxima and minima of the two waves are aligned, that is, when the waves are “in phase”, the total amplitude is the sum of the individual amplitudes of the two waves, and a loud “beat” is heard. When the maximum of one wave aligns with the minimum of the other, the total amplitude is the difference between individual amplitudes of the two waves, the result being a brief silence.

While beat frequencies are a manifestation of a time-varying interference pattern, conventional interferometers rely upon space-varying interference patterns.

FIG. 1 shows a schematic representation of a conventional interferometer 10, of a type sometimes referred to as a Michelson interferometer. A beam of light 12 is directed towards a beam splitter 14. The beam 12 is split into a reference beam 16 and a test beam 18.

The test beam 18 is directed towards a test return reflector 20, which reflects the test beam 18, now referred to as the test return beam 22, back towards the beam splitter 14. The beam splitter splits the test return beam 22 into a test sensor beam 24 and a test diverted beam (not shown). The test sensor beam 24 is directed towards a sensor 26. The test diverted beam passes through the beam splitter 14, and typically is lost from the system.

The reference beam 16 is directed towards a reference return reflector 28, which reflects the reference beam 16, now referred to as the reference return beam 30, back towards the beam splitter 14. The beam splitter splits the reference return beam 30 into a reference sensor beam 32 and a reference diverted beam (not shown). The reference sensor beam 32 is directed towards the sensor 26. The reference diverted beam passes through the beam splitter 14, and typically is lost from the system.

The test sensor beam 24 and the reference sensor beam 32 combine at the sensor, and the sensor 26 detects the total intensity of the combined test sensor beam 24 and reference sensor beam 32.

The test return reflector 20 is movable in a direction 34 so as to vary the distance between the test return reflector 20 and the beam splitter 14.

For purposes of convenience, conventional interferometers typically use a beam 12 that is coherent, that is, a beam that is composed of waves of the same frequency (monochromatic) and having the same wave phase (in-phase). Beams from lasers, in particular helium-neon (HeNe) lasers, are widely used.

Given that the beam 12 is monochromatic, it will be appreciated by those of knowledge in the art that the intensity of the combined test sensor beam 24 and reference sensor beam 32 depends on the phase difference between the test sensor beam 24 and the reference sensor beam 32. It will likewise be appreciated that the phase difference between the test sensor beam 24 and the reference sensor beam 32 depends on the difference in the optical paths traveled by each beam.

Moving the test return reflector 20 a displacement d increases the optical path length traveled by the test sensor beam 24 by 2d, but does not change the optical path length traveled by the reference sensor beam 32. Thus, the phase difference between the test sensor beam 24 and the reference sensor beam 32 may be adjusted by moving the test return reflector 20.

The variation in relative wave phase as the test return reflector 20 moves manifests as a variation in intensity received by the sensor 26. The variation is illustrated in FIGS. 2 and 3.

FIG. 2 shows a wave plot of a first wave 40 and a second wave 42. The first and second waves 40 and 42 are in phase, that is, their maxima and minima are aligned. If the first and second waves 40 and 42 are combined, the combined wave 44 has an amplitude equal to the combined amplitudes of the first and second waves 40 and 42.

In the case shown in FIG. 2, the first and second waves 40 and 42 have equal amplitudes, so the amplitude of the combined wave 44 is twice the amplitude of either of the first or second waves 40 and 42.

FIG. 3 shows a wave plot of a first wave 50 and a second wave 52. The first and second waves 50 and 52 are 180 degrees out of phase, that is, the maxima of the first wave 50 are aligned with the minima of the second wave 52. If the first and second waves 50 and 52 are combined, the combined wave 54 has an amplitude equal to the difference between the amplitudes of the first and second waves 50 and 52.

In the case shown in FIG. 3, the first and second waves 50 and 52 have equal amplitudes, so the amplitude of the combined wave 54 is zero.

Returning again to FIG. 1, as the test return reflector 20 moves, the phase difference of the test sensor beam 24 and the reference sensor beam 32 changes, and consequently the intensity at the sensor 26 varies periodically from a maximum to a minimum. The distance between one peak intensity and the next peak intensity as measured at the sensor 26 corresponds to a distance of one half the wavelength of the beam 12.

Thus, with a beam 12 of known wavelength, it is possible to measure the distance traveled by the test return reflector 20. Likewise, if the distance traveled by the test return reflector 20 is known, it is possible to measure the wavelength of the beam 12.

In mathematic terms, the intensity of the combined test sensor beam 24 and the reference sensor beam 32 at the sensor 26 while moving the test return reflector 20 is given by Equation 1.

$$I = {I}_{o} [ 1 + cos ( \frac{2 π d}{λ} ) ]$$

wherein

I is the intensity after moving the movable reflector mount;

Iₒ is the intensity before moving the movable reflector mount;

d is the displacement the test return reflector 20 is moved; and

λ is the wavelength of the beam 12.

Conventional interferometers are useful for a variety of applications. For example, they are used in Fourier transform spectrometers.

A conventional Fourier transform spectrometer 100 is illustrated schematically in FIG. 4.

As shown, the conventional spectrometer 100 includes a conventional comparison interferometer 110. The comparison interferometer 110 is substantially similar to the interferometer 10 as illustrated in FIG. 1 and as described above.

In the comparison interferometer 110, a beam of light 112 is directed towards a beam splitter 114. Typically, the beam 112 is coherent light having a known wavelength. The beam 112 is split into a reference beam 116 and a test beam 118.

The test beam 118 is directed towards a test return reflector 120, which reflects the test beam 118, now referred to as the test return beam 122, back towards the beam splitter 114. The beam splitter splits the test return beam 122 into a test sensor beam 124 and a test diverted beam (not shown). The test sensor beam 124 is directed towards a sensor 126. The test diverted beam passes through the beam splitter 114, and typically is lost from the system.

The reference beam 116 is directed towards a reference return reflector 128, which reflects the reference beam 116, now referred to as the reference return beam 130, back towards the beam splitter 114. The beam splitter splits the reference return beam 130 into a reference sensor beam 132 and a reference diverted beam (not shown). The reference sensor beam 132 is directed towards the sensor 126. The reference diverted beam passes through the beam splitter 114, and typically is lost from the system.

The test sensor beam 124 and the reference sensor beam 132 combine at the sensor, and the sensor 126 detects the total intensity of the combined test sensor beam 124 and reference sensor beam 132.

In addition, the conventional spectrometer 100 includes a conventional sample interferometer 150. The sample interferometer 150 is substantially similar to the interferometer 10 as illustrated in FIG. 1 and as described above.

In the comparison interferometer 150, a beam of light 162 is directed towards a beam splitter 164. The wavelength of the beam 162 may be known or unknown. Although the beam 112 entering the comparison interferometer 110 is typically from a laser, and so is typically well-collimated, the beam 162 may not be well-collimated. For this reason, the sample interferometer 150 may include optics 152 for collimating or otherwise processing the beam 162.

The beam 162 is split into a reference beam 166 and a test beam 168.

The test beam 168 is directed towards a test return reflector 170, which reflects the test beam 168, now referred to as the test return beam 172, back towards the beam splitter 164. The beam splitter splits the test return beam 172 into a test sensor beam 174 and a test diverted beam (not shown). The test sensor beam 174 is directed towards a sensor 176. The test diverted beam passes through the beam splitter 164, and typically is lost from the system.

The reference beam 166 is directed towards a reference return reflector 178, which reflects the reference beam 166, now referred to as the reference return beam 180, back towards the beam splitter 164. The beam splitter splits the reference return beam 180 into a reference sensor beam 182 and a reference diverted beam (not shown). The reference sensor beam 182 is directed towards the sensor 176. The reference diverted beam passes through the beam splitter 164, and typically is lost from the system.

The test sensor beam 174 and the reference sensor beam 182 combine at the sensor, and the sensor 176 detects the total intensity of the combined test sensor beam 174 and reference sensor beam 182.

In the conventional spectrometer 100, the test return reflector 120 in the comparison interferometer 110 and the test return reflector 170 in the sample interferometer 150 are disposed on a movable reflector mount 102, so as to be movable therewith. The movable reflector mount 102 is movable in a direction 104 so as to simultaneously vary the distance between the test return reflector 120 and the beam splitter 114 in the comparison interferometer 110, and the distance between the test return reflector 170 and the beam splitter 164 in the sample interferometer 150. When the distance between the test return reflector 120 and the beam splitter 114 in the comparison interferometer 110 increases, the distance between the test return reflector 170 and the beam splitter 164 in the sample interferometer 150 decreases by a like amount, and vice versa. The variations in distance are equal in magnitude, but opposite in direction.

By comparing the number of peaks detected at sensor 176 in the sample interferometer 150 with the number of peaks detected at sensor 126 in the comparison interferometer 110 for a given displacement d of the movable reflector mount 102, and in view of the known wavelength of the beam 112, a conventional spectrometer may be used to measure the wavelength of the beam 162. It is not even necessary to know or measure the displacement d, as it is equal for both the comparison interferometer 110 and the sample interferometer 150.

However, conventional interferometers, and devices such as conventional spectrometers that employ conventional interferometers, suffer from several drawbacks. For example, conventional interferometers are limited in terms of their resolution.

For practical reasons, distance measurements with conventional interferometers are made by counting the number of intensity peaks as detected at the sensor. This is because it is relatively simple to identify a peak in intensity; it is not necessary to measure the intensity precisely, merely to note that a peak has occurred. Identifying points between peaks requires precise measurements of intensity, which is extremely difficult for most applications.

As a result, the minimum increment measurable with a conventional interferometer is substantially limited to the wavelength of the beam of light that is used. For light from a common HeNe laser, this wavelength is approximately 633 nm. Measuring distances smaller than the wavelength with a conventional interferometer is impractical.

Attempts have been made previously to overcome this limit. None have been entirely satisfactory.

For some applications it is possible to employ a light beam having a resolution smaller than the minimum distance that is to be measured. However, the production and handling of very short wavelengths of light is technically complex. For example, there are few suitable sources of coherent light with wavelengths of less than a few hundred nm, and optics for directing and detecting light of such wavelengths is typically expensive, delicate, and/or complex, when they are available at all.

It is also possible in principle to sense variations in intensity caused by phase changes representative of less than one full wavelength of travel for the test return reflector. However, known devices for this are complex and expensive. They also suffer from inaccuracies in measurement due to the difficulty of measuring intensities between peaks. In addition, even these devices are limited to measurements corresponding to approximately one quarter the wavelength of the light. Furthermore, as the gain resolution in such devices increases, the total distance that the test return reflector may move decreases, causing difficulties in spectrometry and other applications.

### SUMMARY OF THE INVENTION

It is the purpose of the claimed invention to overcome these difficulties, thereby providing an improved apparatus and method for interferometry, in particular as applied to spectrometry.

It is more particularly the purpose of the claimed invention to provide an apparatus and method for interferometry with resolution smaller than the wavelength of the light beam that is used, over a broad range of distances. As applied to spectrometry, it is the purpose of the claimed invention to provide an apparatus and method of measuring wavelengths smaller than the wavelength of a known comparison light beam over a broad range of wavelengths.

In accordance with the principles of the claimed invention, this may be accomplished by arranging an interferometry system such that a variation of some distance in the system increases the optical path of the test beam by that distance multiplied by an integer greater than 1.

As a result, the number of interference peaks that occur when that distance is varied is increased by a factor equal to that integer. This provides a resolution similar to what would be expected if the wavelength of the beam were reduced by a factor equal to the integer.

An embodiment of an interferometer in accordance with the principles of the claimed invention includes a beam splitter for splitting a beam incident thereon into a reference beam and a test beam, a sensor, a reference path for directing the reference beam to the sensor, and a variable test path for directing the test beam to the sensor. The sensor is adapted to detect an interference of the test beam and the reference beam incident thereon.

The test path has at least two segments of variable lengths. The test path is arranged such that varying the length of the test path comprises varying the lengths of all of the segments.

Thus, the variation in the optical path length of the test path typically is at least twice the variation in the lengths of each leg of the path. For a change d in the length of the segments, the optical path length changes at least twice as much, 2d; hence, twice as many peaks will be detected at the sensor as would be detected if the total change in the optical path length were only d.

As a result, for purposes of interferometry, doubling the optical path variation is effectively similar to halving the wavelength of the beam.

An embodiment of a method of interferometry in accordance with the principles of the claimed invention similarly includes the steps of splitting a beam into a reference beam and a test beam, directing the test beam along a test path, directing the reference beam along a variable reference path, combining the reference beam and the test beam, and sensing an interference of the combination of the reference beam and the test beam.

The test path has at least two segments of variable lengths, such that varying the test path varies the lengths of all of the variable legs equally.

The test path is varied to vary the interference of the test beam and the reference beam.

In more particular structural terms, an exemplary embodiment of an interferometer in accordance with the principles of the claimed invention includes a beam splitter, at least one test path reflector, a fixed reflector mount, a movable reflector mount with at least one test path reflector disposed thereon and movable therewith, a reference return reflector, a test return reflector disposed on either the fixed reflector mount or the movable reflector mount, and a sensor.

These components are in communication such that a beam incident upon the beam splitter is split into a reference beam and a test beam, the reference beam being directed to the reference return reflector and the test beam being directed to the test return reflector via the test path reflector(s).

The test beam incident upon the test return reflector is reflected as a test return beam directed back to the beam splitter via the test path reflector(s). At the beam splitter, it is split into a test sensor beam and a test diverted beam. The test sensor beam is directed to the sensor. The test diverted beam typically is lost from the system.

The reference beam incident upon the reference return reflector is reflected as a reference return beam directed to the beam splitter. At the beam splitter, it is split into a reference sensor beam and a reference diverted beam. The reference sensor beam is directed to the sensor. The reference diverted beam typically is lost from the system.

The sensor is adapted to detect the interference of the test sensor beam and the reference sensor beam.

In addition, these components are arranged such that a displacement of the movable reflector mount changes the length of the optical path between said beam splitter and said test return reflector by 2*N*d, d being the displacement of the movable reflector mount, and N being an integer greater than 1.

That is, the variation in the optical path length between the beam splitter and the test return reflector is at least twice the displacement of the movable reflector mount. For a displacement d of the movable reflector mount, the optical path length changes at least twice as much, 2d; hence, twice as many peaks will be detected at the sensor as would be detected if the total change in the optical path length were only d.

Likewise, in more particular structural terms, an exemplary embodiment of a method of interferometry in accordance with the principles of the claimed invention includes the steps of splitting a beam incident on a beam splitter into a reference beam and a test beam, directing the reference beam to a reference return reflector, and directing the test beam to a test return reflector via at least one test path reflector.

The test beam incident upon said test return reflector is directed as a test return beam back to the beam splitter via the test path reflector(s). The test return beam incident upon said beam splitter is split into a test sensor beam and a test diverted beam. The test sensor beam is directed to a sensor. The test diverted beam is typically lost from the system.

The reference beam incident upon said reference return reflector is directed as a reference return beam incident to the beam splitter. The reference return beam incident upon the beam splitter is split into a reference sensor beam and a reference diverted beam. The reference sensor beam is directed to the sensor. The reference diverted beam is typically lost from the system.

The sensor detects the interference of the test sensor beam and the reference sensor beam.

In addition, at least one of the test path reflector(s) is moved such that a displacement thereof changes the optical path between the beam splitter and the test return reflector by 2*N*d, d being the displacement of the test path reflector(s) and N being an integer greater than 1.

Furthermore, the claimed invention includes an apparatus and method for spectrometry, wherein the apparatus and method for interferometry described herein are used to provide comparison interferometry for spectrometry.

### BRIEF DESCRIPTION OF THE DRAWINGS

Like reference numbers generally indicate corresponding elements in the figures.

FIG. 1 shows a schematic of a conventional Michelson interferometer, as known from prior art.

FIG. 2 shows constructive wave interference, as known from prior art.

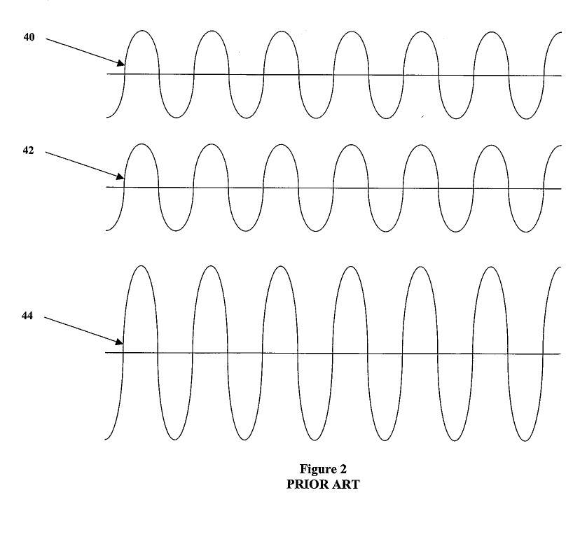

FIG. 3 shows destructive wave interference, as known from prior art.

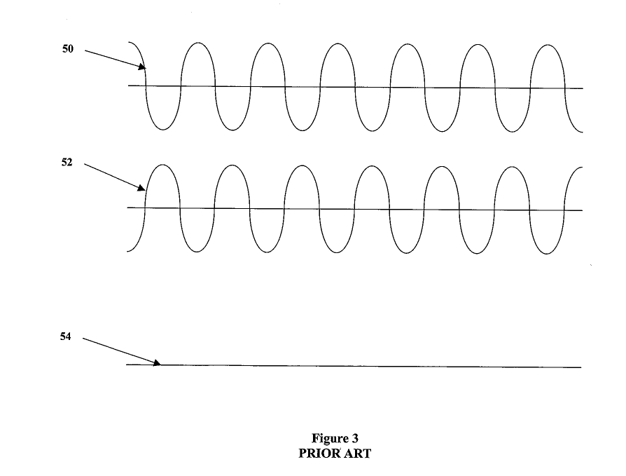

FIG. 4 shows a conventional Fourier transform spectrometer, as known from prior art.

FIG. 5 shows an embodiment of an interferometer in accordance with the principles of the claimed invention, with a test path having two variable-length segments, using prisms as test path reflectors.

FIG. 6 shows an alternative embodiment of an interferometer in accordance with the principles of the claimed invention, with a test path having two variable-length segments, using mirrors as test path reflectors.

FIG. 7 shows an alternative embodiment of an interferometer in accordance with the principles of the claimed invention, with a test path having two variable-length segments, using light pipes as test path reflectors.

FIG. 8 shows an exemplary embodiment of an interferometer in accordance with the principles of the claimed invention, with a test path having three variable-length segments.

FIG. 9 shows an exemplary embodiment of an interferometer in accordance with the principles of the claimed invention, with a test path having four variable-length segments.

FIG. 10 shows an exemplary embodiment of a spectrometer, incorporating an interferometer similar to that shown in FIG. 5 as a comparison interferometer.

### DETAILED DESCRIPTION OF THE PREFERRED EMBODIMENT

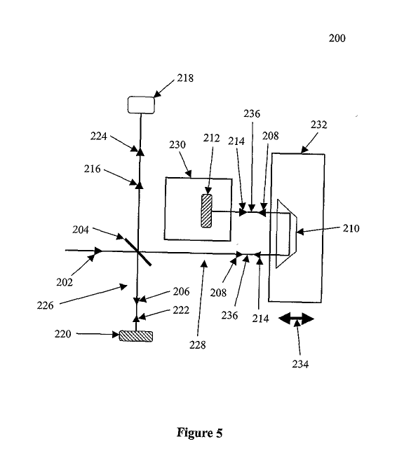

Referring to FIG. 5, an embodiment of an interferometer 200 in accordance with the principles of the claimed invention is shown therein.

A beam of light 202 is directed towards a beam splitter 204. The beam 202 is split into a reference beam 206 and a test beam 208.

As illustrated in FIG. 5, the beam splitter 204 comprises a partially-silvered mirror offset from the beam 202 by 45 degrees. However, this is exemplary only. A variety of other beam splitters may be equally suitable. Beam splitters are well-known, and are not further described herein.

The beam 202 is advantageously a laser beam. In particular, a laser beam having a wavelength of 633 nm, as that produced by a HeNe laser is suitable for use with the claimed invention. However, this is exemplary only. Beams of other wavelengths may be equally suitable for certain embodiments of the claimed invention. Likewise, beams of waves other than electromagnetic waves, including but not limited to sound waves, may be equally suitable for certain embodiments.

Beams and sources for producing beams are well-known, and are not further described herein.

The test beam 208 is directed by the beam splitter 204 towards a test path reflector 210. The test path reflector 210 directs the test beam 208 to a test return reflector 212.

The test beam 208, when incident upon the test return reflector 212, is reflected by the test return reflector 212 so as to return along the path it traveled to reach the test return reflector 212. Once reflected by the test return reflector 212, the test beam 208 is referred to herein as the test return beam 214.

The test return beam 214 is directed by the test return reflector 212 back towards the test path reflector 210. The test path reflector 210 directs the test return beam 214 back to the beam splitter 204.

The beam splitter 204 splits the test return beam 214 into a test sensor beam 216 and a test diverted beam. The test diverted beam typically is lost from the system, exiting for example in the direction that the original beam 202 entered. The test diverted beam is of no consequence to the function of the invention, and is not illustrated in FIG. 5.

The test sensor beam 216 is directed by the beam splitter 204 towards a sensor 218.

Meanwhile, the reference beam 206 is directed by the beam splitter 204 towards a reference return reflector 220.

The reference beam 206, when incident upon the reference return reflector 220, is reflected by the reference return reflector 220 so as to return along the path it traveled to reach the reference return reflector 220. Once reflected by the reference return reflector 220, the reference beam 206 is referred to herein as the reference return beam 222.

The reference return beam 222 is directed by the reference return reflector 220 back towards the beam splitter 204.

The beam splitter 204 splits the reference return beam 222 into a reference sensor beam 224 and a reference diverted beam. The reference diverted beam typically is lost from the system, exiting for example in the direction that the original beam 202 entered. The reference diverted beam is of no consequence to the function of the invention, and is not illustrated in FIG. 5.

The reference sensor beam 224 is directed towards the sensor 218.

The sensor 218 is adapted to measure the intensity of the combination of the test sensor beam 216 and the reference sensor beam 224 incident thereon. A wide variety of sensors may be suitable. For example, charge-coupled device (CCD) sensors are available that detect electromagnetic radiation, and provide a digital output indicative of the intensity thereof. However, this is exemplary only, and other sensors, including but not limited to analog sensors, may be equally suitable.

Sensors are well known, and are not described further herein.

As may be seen from FIG. 5, the route traveled by the reference beam 206, the reference return beam 222, and the reference sensor beam 224 may be considered collectively as an optical path, referenced herein as the reference path 226.

Likewise, the route traveled by the test beam 208, the test return beam 214, and the test sensor beam 216 may be considered collectively another optical path, referenced herein as the test path 228.

At the sensor 218, the test sensor beam 216 and the reference sensor beam 224 combine and interfere. The intensity of the combination of the test sensor beam 216 and the reference sensor beam 224 at the sensor 218 depends on the phase difference between the test sensor beam 216 and the reference sensor beam 224.

The phase difference in turn depends on the difference in the lengths of the optical paths 226 and 228.

In the exemplary interferometer 200 illustrated in FIG. 5, the test return reflector 212 is disposed on a fixed reflector mount 230. As used herein with respect to the fixed reflector mount 230, the term “fixed” means that the fixed reflector mount 230 is not adapted to be movable during the operation of the interferometer 200. For certain embodiments, however, it may be advantageous for the fixed reflector mount 230 to be adjustable so as to slightly modify the performance of the interferometer 200, to be removable for maintenance, etc.

It is furthermore noted that in certain embodiments, it may be advantageous for additional components to be fixed, i.e. the sensor 218, the beam splitter 204, and the reference return reflector 220. In embodiments wherein one or more components are fixed, it is not necessary that the fixed reflector mount 230 is a separate component from whatever the other fixed components might be fixed to. However, for purposes of clarity, the fixed reflector mount 230 is illustrated herein as a separate component.

In contrast, the test path reflector 210 is disposed on a movable reflector mount 232, and is movable therewith. The movable reflector mount 232 is movable with respect to the fixed reflector mount 230 in a direction of motion 234.

As may be seen from FIG. 5, the test path 228 includes two segments 236 having variable length. The direction of motion 234 of the movable reflector mount 232 is such that when the movable reflector mount 232 moves, the length of the segments 236 increases or decreases. In the embodiment illustrated, the lengths of the segments 236 change by an equal amount for any movement of the movable reflector mount 232 in the direction of motion 234.

As a result, in the exemplary interferometer 200 shown in FIG. 5, the total length of the test path 228 increases or decreases by twice the distance d that the movable reflector mount 232 moves. That is, for a given movement d of the movable reflector mount 232, the test path 228 changes by a distance 2d.

The interference between the test sensor beam 216 and the reference sensor beam 224 as detected at the sensor 218 varies based on the length of the test path 228, regardless of the actual physical motions involved. Thus, mathematically, for the interferometer 200 illustrated in FIG. 5, the intensity of the interfering test sensor beam 216 and reference sensor beam 224 may be described using Equation 2:

$$I = {I}_{o} [ 1 + cos ( \frac{4 π d}{λ} ) ]$$

wherein

I is the intensity after moving the movable reflector mount;

Iₒ is the intensity before moving the movable reflector mount;

d is the displacement the movable reflector mount 232 is moved; and

λ is the wavelength of the beam 202.

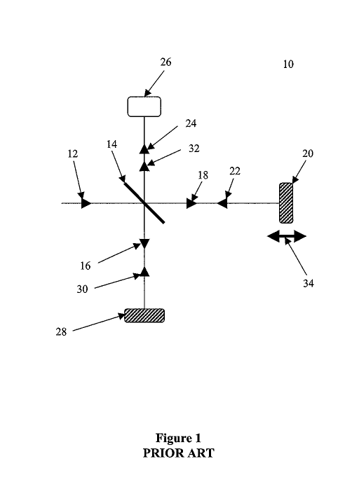

Because the test path 228 is changed by 2d for a movement d of the movable reflector mount 232, the phase difference between the test sensor beam 216 and the reference sensor beam 224 as detected at the sensor 218 varies twice as rapidly in the embodiment of an interferometer 200 illustrated in FIG. 5 as it would in the conventional interferometer 10 illustrated in FIG. 1.

In operational terms, then, for beams 12 and 202 of equal wavelength, the interferometer 200 illustrated in FIG. 5 has a minimum resolution that is half that of the conventional interferometer 10 illustrated in FIG. 1 with a beam 12 of equal wavelength. Thus, the precision of measurement is effectively doubled in the embodiment illustrated in FIG. 5.

It is emphasized that although the test path 228 changes by 2d for a movement d of the movable reflector mount 232, it is not necessary to physically move any part of the interferometer a distance of 2d. The physical motions of the interferometer 200 need not be any larger than in a conventional interferometer 10.

It is noted that a path reflector 210 may include multiple reflecting surfaces. For example, as illustrated in FIG. 5, the test path reflector 210 reflects the test beam 208 and the test return beam 214 from two of its surfaces. However, this is exemplary only. Path reflectors 210 with more than two reflecting surfaces may be equally suitable. Likewise, path reflectors 210 with fewer than two reflecting surfaces may be suitable.

Functionally, it is necessary for a path reflector 210 to reflect a beam incident thereon across the space separating the fixed reflector mount 230 and the movable reflector mount 232. The precise number of reflections performed by each test path reflector 210 is secondary.

Likewise, the precise shape of the path followed by the test beam 208 and the test return beam 214 is not critical. As illustrated herein, the segments 236 are shown to be parallel to the direction of motion 234. However, this is exemplary only. Although it is mathematically convenient in certain embodiments of the claimed invention for the segments 236 to be parallel to the direction of motion 234, the segments may be aligned at an angle to the direction of motion 234.

Furthermore, although it is mathematically convenient in certain embodiments of the claimed invention for the segments 236 to have the same alignment relative to the direction of motion 234, this is also exemplary only, and is not necessary.

As illustrated in FIG. 5, the test path reflector 210 is a prism. However, this is exemplary only. A variety of other test path reflectors 210 may be equally suitable.

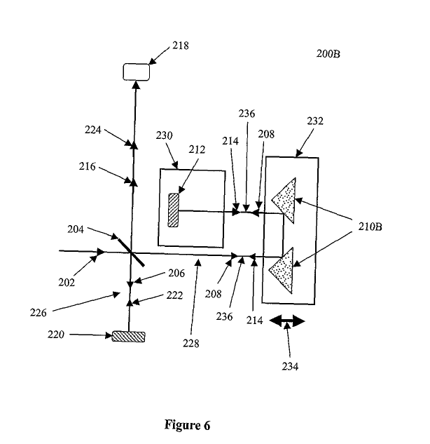

For example, FIG. 6 shows an embodiment of an interferometer 200B in accordance with the principles of the claimed invention. As illustrated, interferometer 200B is essentially similar to interferometer 200 as shown in FIG. 5, except that in interferometer 200B the test path reflector 210B consists of a pair of mirrored prisms. Other elements are as shown in FIG. 5, and as described above.

Even though the test path reflector 210B as illustrated in FIG. 6 includes two separate prisms, it is noted that these mirrored prisms together perform the function of a single test path reflector 210B, namely, redirecting the test beam 208 and the test return beam 214 across the space between the movable reflector mount 232 and the fixed reflector mount 234. Thus, the pair of mirrored prisms illustrated in FIG. 6 is nevertheless considered to be a single test path reflector 210B for purposes of discussion herein.

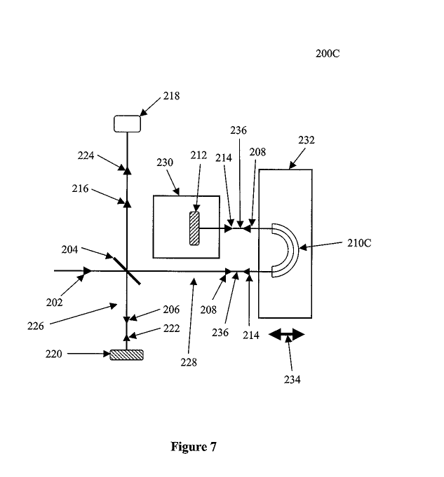

FIG. 7 shows an embodiment of an interferometer 200C in accordance with the principles of the claimed invention. As illustrated, interferometer 200C is essentially similar to interferometer 200 as shown in FIG. 5, except that in interferometer 200C the test path reflector 210C consists of a light pipe with a 180 degree curve therein. Other elements are as shown in FIG. 5, and as described above.

FIGS. 5, 6, and 7 are exemplary only. Other test path reflectors than those illustrated therein, including but not limited to plane mirrors, may be equally suitable.

Although FIGS. 5, 6, and 7 illustrate embodiments with only a single test path reflector, this is exemplary only. There is no theoretical limitation to the number of test path reflectors that may be incorporated into an interferometer in accordance with the principles of the claimed invention.

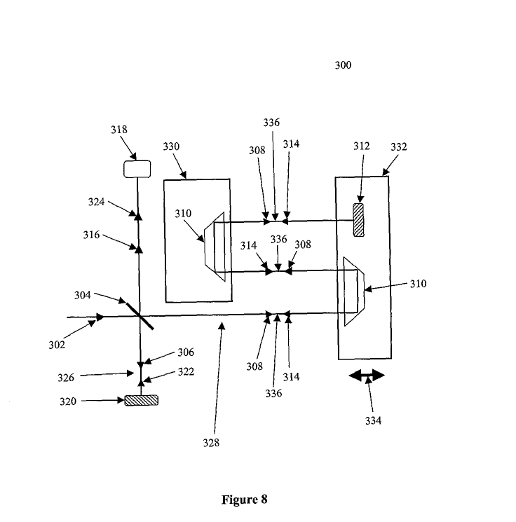

FIG. 8 shows an embodiment of an interferometer 300 that has two test path reflectors 310. In the embodiment shown, a motion d of the movable reflector mount 332 produces a change of 3d in the length of the test path 328. Thus, the resolution of the embodiment of FIG. 8 is three times that of a conventional interferometer 10, as may be described by Equation 3:

$$I = {I}_{o} [ 1 + cos ( \frac{6 π d}{λ} ) ]$$

wherein

I is the intensity after moving the movable reflector mount;

Iₒ is the intensity before moving the movable reflector mount;

d is the displacement the movable reflector mount 332 is moved; and

λ is the wavelength of the beam 302.

The structure of the exemplary embodiment in FIG. 8 is similar to that of FIG. 5. A beam of light 302 is directed towards a beam splitter 304. The beam 302 is split into a reference beam 306 and a test beam 308.

The test beam 308 is directed by the beam splitter 304 towards a test path reflector 310. The test path reflector 310 directs the test beam 308 to the next test path reflector 310, which in turn directs the test beam 308 to the test return reflector 312.

The test beam 308 is reflected by the test return reflector 312 so as to return along the path it traveled. Once reflected by the test return reflector 312, the test beam 308 is referred to herein as the test return beam 314.

The test return beam 314 is directed by the test return reflector 312 via the test path reflectors 310 back towards the beam splitter 304.

The beam splitter 304 splits the test return beam 314 into a test sensor beam 316 and a test diverted beam (not shown). The test sensor beam 316 is directed by the beam splitter 304 towards a sensor 318.

Meanwhile, the reference beam 306 is directed by the beam splitter 304 towards a reference return reflector 320.

The reference beam 306 is reflected by the reference return reflector 320 so as to return along the path it traveled. Once reflected by the reference return reflector 320, the reference beam 306 is referred to herein as the reference return beam 322.

The reference return beam 322 is directed by the reference return reflector 320 back towards the beam splitter 304.

The beam splitter 304 splits the reference return beam 322 into a reference sensor beam 324 and a reference diverted beam (not shown). The reference sensor beam 324 is directed towards the sensor 318.

The sensor 318 is adapted to measure the intensity of the combination of the test sensor beam 316 and the reference sensor beam 324 incident thereon.

The route traveled by the reference beam 306, the reference return beam 322, and the reference sensor beam 324 may be considered collectively as an optical path, referenced herein as the reference path 326.

Likewise, the route traveled by the test beam 308, the test return beam 314, and the test sensor beam 316 may be considered collectively another optical path, referenced herein as the test path 328.

At the sensor 318, the test sensor beam 316 and the reference sensor beam 324 combine and interfere, the intensity of the combination being determined by the phase difference between the test sensor beam 316 and the reference sensor beam 324.

In the exemplary interferometer 300 illustrated in FIG. 8, the test return reflector 312 is disposed on a movable reflector mount 332, and is movable therewith. It is noted that the embodiment of FIG. 8 differs in this respect from the embodiment of FIG. 5.

One of the test path reflectors 310 is also disposed on the movable reflector mount 332, and is movable therewith.

The other test path reflector 310 is disposed on the a fixed reflector mount 330.

As may be understood from a comparison of FIGS. 5 and 8, it is necessary that at least one test path reflector is disposed on a movable reflector mount. In embodiments having more than one test path reflector, it is not necessary that all of the test path reflectors are disposed on the movable reflector mount.

As may also be understood from a comparison of FIGS. 5 and 8, the test return reflector may be disposed on either the movable reflector mount or the fixed reflector mount.

Returning to FIG. 8, the test path 328 includes three segments 336 having variable length. The direction of motion 334 of the movable reflector mount 332 is such that when the movable reflector mount 332 moves, the length of the segments 336 increases or decreases. The lengths of the segments 336 change by an equal amount for any movement of the movable reflector mount 332 in the direction of motion 334.

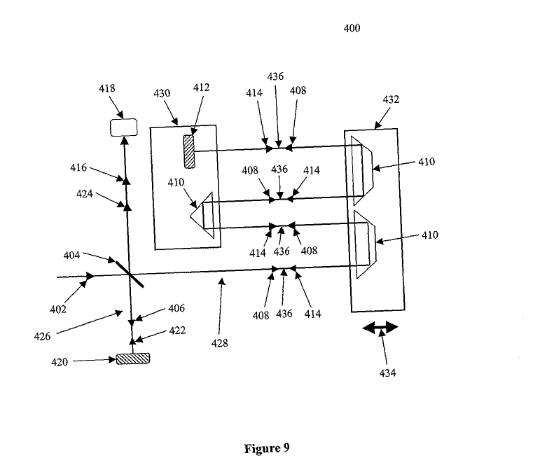

FIG. 9 shows an embodiment of an interferometer 400 that has three test path reflectors 410. A motion d of the movable reflector mount 432 produces a change of 4d in the length of the test path 428. Thus, the resolution is four times that of a conventional interferometer 10, as may be described by Equation 4:

$$I = {I}_{o} [ 1 + cos ( \frac{8 π d}{λ} ) ]$$

wherein

I is the intensity after moving the movable reflector mount;

Iₒ is the intensity before moving the movable reflector mount;

d is the displacement the movable reflector mount 432 is moved; and

λ is the wavelength of the beam 402.

The structure of the exemplary embodiment in FIG. 9 is similar to that of FIG. 8. Abeam of light 402 is directed towards abeam splitter 404. The beam 402 is split into a reference beam 406 and a test beam 408.

The test beam 408 is directed by the beam splitter 404 towards each of the test path reflectors 410, one after another, ultimately being directed to the test return reflector 412.

The test beam 408 is reflected by the test return reflector 412 so as to return along the path it traveled. Once reflected by the test return reflector 412, the test beam 408 is referred to herein as the test return beam 414.

The test return beam 414 is directed by the test return reflector 412 via the test path reflectors 410 back towards the beam splitter 404.

The beam splitter 404 splits the test return beam 414 into a test sensor beam 416 and a test diverted beam (not shown). The test sensor beam 416 is directed by the beam splitter 404 towards a sensor 418.

Meanwhile, the reference beam 406 is directed by the beam splitter 404 towards a reference return reflector 420.

The reference beam 406 is reflected by the reference return reflector 420 so as to return along the path it traveled. Once reflected by the reference return reflector 420, the reference beam 406 is referred to herein as the reference return beam 422.

The reference return beam 422 is directed by the reference return reflector 420 back towards the beam splitter 404.

The beam splitter 404 splits the reference return beam 422 into a reference sensor beam 424 and a reference diverted beam (not shown). The reference sensor beam 424 is directed towards the sensor 418.

The sensor 418 is adapted to measure the intensity of the combination of the test sensor beam 416 and the reference sensor beam 424 incident thereon.

The route traveled by the reference beam 406, the reference return beam 422, and the reference sensor beam 424 may be considered collectively as an optical path, referenced herein as the reference path 426.

Likewise, the route traveled by the test beam 408, the test return beam 414, and the test sensor beam 416 may be considered collectively another optical path, referenced herein as the test path 428.

At the sensor 418, the test sensor beam 416 and the reference sensor beam 424 combine and interfere, the intensity of the combination being determined by the phase difference between the test sensor beam 416 and the reference sensor beam 424.

Two of the test path reflectors 410 are disposed on the movable reflector mount 432, and are movable therewith.

The other test path reflector 410 is disposed on the a fixed reflector mount 430. The test return reflector 412 is also disposed on the fixed reflector mount 430.

The test path 428 includes four segments 436 having variable length. The direction of motion 434 of the movable reflector mount 432 is such that when the movable reflector mount 432 moves, the length of the segments 436 increases or decreases. The lengths of the segments 436 change by an equal amount for any movement of the movable reflector mount 432 in the direction of motion 434.

As may be seen from FIGS. 5, 8, and 9, there is essentially no limit to the number of test path reflectors that may be incorporated into an embodiment of an interferometer in accordance with the principles of the claimed invention.

Consequently, the resolution is effectively unlimited, until the point at which atomic vibrations of the optics become significant.

In general, the interference of an interferometer in accordance with the principles of the claimed invention, and similar to that shown in FIGS. 5, 8, and 9 except for the number of test path reflectors, as may be described by Equation 5:

$$I = {I}_{o} [ 1 + cos ( \frac{2 N π d}{λ} ) ]$$

wherein

I is the intensity after moving the movable reflector mount;

Iₒ is the intensity before moving the movable reflector mount;

N is the number of test path reflectors plus 1;

d is the displacement the movable reflector mount is moved; and

λ is the wavelength of the beam.

It is noted that N also is equal to the number of variable-length segments present in the test path.

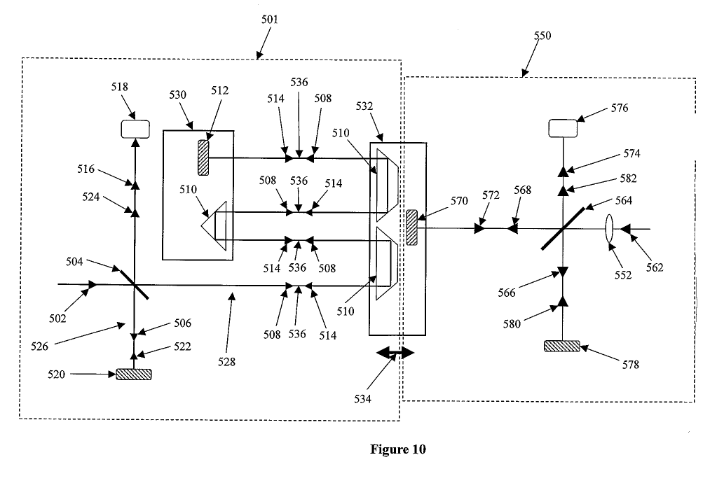

Referring to FIG. 10, an embodiment of a spectrometer 500 in accordance with the principles of the claimed invention is shown therein.

The spectrometer 500 illustrated in FIG. 10 includes a comparison interferometer 501 that is substantially similar to that shown in FIG. 9.

The comments with regard to the particulars of structure previously described with regard to interferometers in accordance with the principles of the claimed invention are also applicable to the comparison interferometer 501.

In addition, it is noted that the comparison interferometer 501 in FIG. 10 includes four test path reflectors 510. However, this is exemplary only. Other interferometers in accordance with the principles of the claimed invention may be suitable for use in embodiments of a spectrometer 500 in accordance with the principles of the claimed invention. In particular, interferometers with different numbers of test path reflectors may be equally suitable.

In the comparison interferometer 501, a beam of light 502 is directed towards a beam splitter 504. The beam 502 is split into a reference beam 506 and a test beam 508.

The test beam 508 is directed by the beam splitter 504 towards each of the test path reflectors 510, one after another, ultimately being directed to the test return reflector 512.

The test beam 508 is reflected by the test return reflector 512 so as to return along the path it traveled. Once reflected by the test return reflector 512, the test beam 508 is referred to herein as the test return beam 514.

The test return beam 514 is directed by the test return reflector 512 via the test path reflectors 510 back towards the beam splitter 504.

The beam splitter 504 splits the test return beam 514 into a test sensor beam 516 and a test diverted beam (not shown). The test sensor beam 516 is directed by the beam splitter 504 towards a sensor 518.

Meanwhile, the reference beam 506 is directed by the beam splitter 504 towards a reference return reflector 520.

The reference beam 506 is reflected by the reference return reflector 520 so as to return along the path it traveled. Once reflected by the reference return reflector 520, the reference beam 506 is referred to herein as the reference return beam 522.

The reference return beam 522 is directed by the reference return reflector 520 back towards the beam splitter 504.

The beam splitter 504 splits the reference return beam 522 into a reference sensor beam 524 and a reference diverted beam (not shown). The reference sensor beam 524 is directed towards the sensor 518.

The sensor 518 is adapted to measure the intensity of the combination of the test sensor beam 516 and the reference sensor beam 524 incident thereon.

The route traveled by the reference beam 506, the reference return beam 522, and the reference sensor beam 524 may be considered collectively as an optical path, referenced herein as the reference path 526.

Likewise, the route traveled by the test beam 508, the test return beam 514, and the test sensor beam 516 may be considered collectively another optical path, referenced herein as the test path 528.

At the sensor 518, the test sensor beam 516 and the reference sensor beam 524 combine and interfere, the intensity of the combination being determined by the phase difference between the test sensor beam 516 and the reference sensor beam 524.

Two of the test path reflectors 510 are disposed on the movable reflector mount 532, and are movable therewith.

The other test path reflector 510 is disposed on the a fixed reflector mount 530. The test return reflector 512 is also disposed on the fixed reflector mount 530.

The test path 528 includes four segments 536 having variable length. The direction of motion 534 of the movable reflector mount 532 is such that when the movable reflector mount 532 moves, the length of the segments 536 increases or decreases. The lengths of the segments 536 change by an equal amount for any movement of the movable reflector mount 532 in the direction of motion 534.

Thus, the resolution of the comparison interferometer 501 may be expressed according to Equation 4, restated here:

$$I = {I}_{o} [ 1 + cos ( \frac{8 π d}{λ} ) ]$$

wherein

I is the intensity after moving the movable reflector mount;

Iₒ is the intensity before moving the movable reflector mount;

d is the displacement the movable reflector mount is moved; and

λ is the wavelength of the beam.

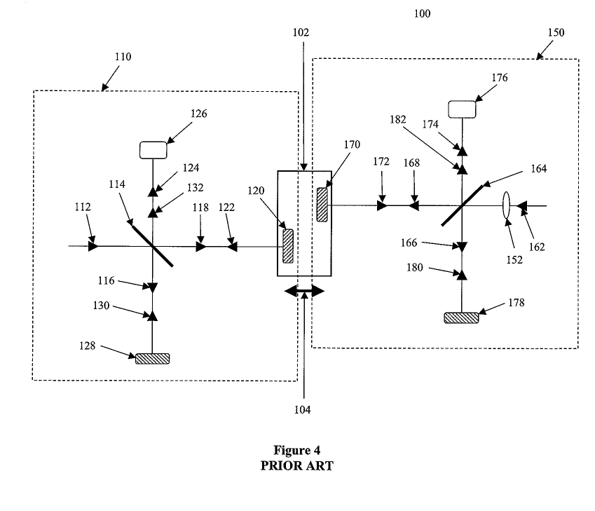

In addition, the exemplary spectrometer 500 illustrated in FIG. 10 includes a sample interferometer 550. The sample interferometer 550 is substantially conventional except as described herein, and is in some ways similar to the sample interferometer 150 illustrated in FIG. 4.

In the sample interferometer 550, a beam of light 562 is directed towards a beam splitter 564. The wavelength of the beam 562 may be known or unknown. The sample interferometer 550 may include optics 552 for collimating or otherwise processing the beam 562. However, this is exemplary only, and embodiments lacking optics 552 may be equally suitable.

The beam 562 is split into a reference beam 566 and a test beam 568.

The test beam 568 is directed towards a test return reflector 570, which reflects the test beam 568, now referred to as the test return beam 572, back towards the beam splitter 564. The beam splitter splits the test return beam 572 into a test sensor beam 574 and a test diverted beam (not shown). The test sensor beam 574 is directed towards a sensor 576.

The reference beam 566 is directed towards a reference return reflector 578, which reflects the reference beam 566, now referred to as the reference return beam 580, back towards the beam splitter 564. The beam splitter splits the reference return beam 580 into a reference sensor beam 582 and a reference diverted beam (not shown). The reference sensor beam 582 is directed towards the sensor 576.

The test sensor beam 574 and the reference sensor beam 582 combine at the sensor 576, and the sensor 576 detects the total intensity of the combined test sensor beam 574 and reference sensor beam 582.

In the spectrometer 500, the test return reflector 512 of the comparison interferometer 501 is disposed on the movable reflector mount 532 so as to be movable therewith, as previously described. Additionally, the test return reflector 570 of the sample interferometer 550 is disposed on the movable reflector mount 532, so as to be movable therewith.

Also as previously described, the movable reflector mount 532 is movable in a direction 534. Because both two of the test path reflectors 510 of the comparison interferometer 501 and the test return reflector 570 of the sample interferometer 550 are disposed on the movable reflector mount 532 and are movable therewith, varying the distance between the test return reflector 512 and the beam splitter 504 of the comparison interferometer 501 simultaneously varies the distance between the test return reflector 570 and the beam splitter 564 of the sample interferometer 550. When the distance between the test return reflector 512 and the beam splitter 504 of the comparison interferometer 501 increases, the distance between the test return reflector 570 and the beam splitter 564 of the sample interferometer 550 decreases by a like amount, and vice versa. The variations in distance are equal in magnitude, but opposite in direction.

By comparing the number of peaks detected at sensor 576 in the sample interferometer 550 with the number of peaks detected at sensor 518 in the comparison interferometer 501 for a given displacement d of the movable reflector mount 532, and in view of the known wavelength of the beam 502, a conventional spectrometer may be used to measure the wavelength of the beam 562. It is not even necessary to know or measure the displacement d, as it is equal for both the comparison interferometer 501 and the sample interferometer 550.

As noted above, the comparison interferometer 501 has a resolution four times better than that of a conventional interferometer 10. Thus, a spectrometer 500 in accordance with the principles of the claimed invention as illustrated in FIG. 10 has a resolution four times better than that of a conventional spectrometer 100, since a comparison interferometer 501 has a resolution four times better than that of a conventional comparison interferometer 110.

As noted above, the resolution of an interferometer in accordance with the principles of the claimed invention is essentially unlimited, since the number of test path reflectors may be extremely large. Consequently, the resolution of a spectrometer in accordance with the principles of the claimed invention is also essentially unlimited.

Furthermore, since the actual distances that the movable reflector mount must move do not increase with the addition of more test path reflectors, the range of a spectrometer in accordance with the principles of the claimed invention is not limited by an improvement in resolution.

Thus, there is no trade-off, and interferometers and spectrometers in accordance with the principles of claimed invention may have essentially unlimited resolution, combined with effectively unlimited range.

In practice, the range is limited only by the ability of the optics to handle a variety of wavelengths. As known optics are available that are suitable for use with ultraviolet, visible, and infrared radiation, embodiments of interferometers and spectrometers in accordance with the principles of claimed invention may have essentially unlimited resolution over a UV-VIS-IR range.

It is noted that the above range is exemplary only, and that embodiments of interferometer and spectrometer with wider or narrower ranges may be equally suitable.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An interferometer, comprising:
a beam splitter for splitting a beam incident thereon into a reference beam and a test beam;
a sensor;
a reference path for directing the reference beam to said sensor;
a variable-length test path for directing the test beam to said sensor;
wherein said test path comprises at least two variable-length segments, such that varying said test path comprises varying all of said at least two variable-length segments; and
wherein said sensor is adapted to detect an interference of the test beam and the reference beam incident thereon.

2. An interferometer according to claim 1, further comprising at least one test path reflector and a test return reflector,
wherein said at least one test path reflector and said test return reflector cooperate with said beam splitter to define said at least two variable-length segments.

3. An interferometer according to claim 2, further comprising a fixed reflector mount and a movable reflector mount,
wherein at least one of said at least one test path reflector is disposed on said movable reflector mount, and said test return reflector is disposed on one of said fixed reflector mount and said movable reflector mount.

4. An interferometer according to claim 3,
wherein moving said movable reflector mount varies said at least two variable length segments.

5. An interferometer according to claim 4,
wherein an intensity of the interference of the test beam and reference beam incident on said sensor corresponds to
$$I = {I}_{o} [ 1 + cos ( \frac{2 N π d}{λ} ) ]$$
I being the intensity of the interference after moving said movable reflector mount;
Iₒ being the intensity of the interference before moving said movable reflector mount;
N being the number of said test path reflectors plus 1;
d being a displacement by which said movable reflector mount is moved; and
λ being a wavelength of the beam.

6. An interferometer according to claim 1,
wherein an intensity of the interference of the test beam and reference beam incident on said sensor corresponds to
$$I = {I}_{o} [ 1 + cos ( \frac{2 N π d}{λ} ) ]$$
I being the intensity of the interference after varying said variable-length segments;
Iₒ being the intensity of the interference before varying said variable-length segments;
N being the number of said variable-length segments;
d being a distance by which said variable-length segments are varied; and
λ being a wavelength of the beam.

7. An interferometer according to claim 2,
wherein said at least one test path reflectors comprise a prism.

8. An interferometer according to claim 2,
wherein said at least one test path reflectors comprises a mirror.

9. A method of interferometry, comprising the steps of:
splitting a beam into a reference beam and a test beam;
directing the test beam along a variable-length test path;
directing the reference beam along a reference path;
combining the reference beam and the test beam;
sensing an interference of the combination of the reference beam and the test beam;
varying said test path to vary said interference;
wherein said test path comprises at least two variable-length segments, such that varying said test path comprises varying all of said at least two variable-length segments.

10. A spectrometer, comprising:
a comparison interferometer, said comparison interferometer comprising:
a comparison beam splitter for splitting a comparison beam of known wavelength incident thereon into a comparison reference beam and a comparison test beam;
a comparison sensor;
a comparison reference path for directing the comparison reference beam to said comparison sensor;
a variable-length comparison test path for directing the comparison test beam to said comparison sensor;
said comparison sensor being adapted to detect an interference of the comparison test beam and the comparison reference beam incident thereon;
wherein said comparison test path comprises at least two variable-length segments, such that varying said comparison test path comprises varying all of said at least two variable-length segments;
said spectrometer further comprising a sample interferometer, said sample interferometer comprising:
a sample beam splitter for splitting a sample beam incident thereon into a sample reference beam and a sample test beam;
a sample sensor;
a sample reference path for directing the sample reference beam to said sample sensor;
a variable-length sample test path for directing the sample test beam to said sample sensor;
said sample sensor being adapted to detect an interference of the sample test beam and the sample reference beam incident thereon;
wherein varying said sample test path causes a variation in all of said variable-length segments of said comparison test path, such that the variation of said sample test path causes a variation of said comparison test path greater in magnitude than the variation of said sample test path.

11. A spectrometer according to claim 10, said comparison spectrometer further comprising at least one comparison test path reflector and a comparison test return reflector,
wherein said at least one comparison test path reflector and said comparison test return reflector cooperate with said comparison beam splitter to define said at least two variable-length segments.

12. A spectrometer according to claim 11, further comprising a movable reflector mount, said comparison interferometer further comprising a fixed reflector mount,
wherein at least one of said at least one comparison test path reflector is disposed on said movable reflector mount, said sample test return reflector is disposed on said movable mount, and said comparison test return reflector is disposed on one of said fixed reflector mount and said movable reflector mount.

13. A spectrometer according to claim 12,
wherein moving said movable reflector mount varies said at least two variable length segments.

14. A spectrometer according to claim 13,
wherein an intensity of the interference of the comparison test beam and comparison reference beam incident on said comparison sensor corresponds to
$$I = {I}_{o} [ 1 + cos ( \frac{2 N π d}{λ} ) ]$$
I being the intensity of the interference before after said movable reflector mount;
Iₒ being the intensity of the interference before moving said movable reflector mount;
N being the number of said comparison test path reflectors plus 1;
d being a displacement by which said movable reflector mount is moved; and
λ being a wavelength of the beam.

15. A spectrometer according to claim 10,
wherein an intensity of the interference of the comparison test beam and comparison reference beam incident on said comparison sensor corresponds to
$$I = {I}_{o} [ 1 + cos ( \frac{2 N π d}{λ} ) ]$$
I being the intensity of the interference after varying said variable-length segments;
Iₒ being the intensity of the interference before varying said variable-length segments;
N being the number of said variable-length segments;
d being a distance by which said variable-length segments are varied; and
λ being a wavelength of the beam.

16. A spectrometer according to claim 11,
wherein said at least one test path reflectors comprises a prism.

17. A spectrometer according to claim 11,
wherein said at least one test path reflectors comprises a mirror.

18. A method of spectrometry, comprising the steps of:
splitting a sample beam into a sample reference beam and a sample test beam;
directing the sample test beam along a sample test path;
directing the sample reference beam along a sample reference path;
combining the sample reference beam and the sample test beam;
sensing a sample interference of the combination of the sample reference beam and the sample test beam;
splitting a comparison beam having a known wavelength into a comparison reference beam and a comparison test beam;
directing the comparison test beam along a variable-length comparison test path;
directing the comparison reference beam along a comparison reference path;
combining the comparison reference beam and the comparison test beam;
sensing a comparison interference of the combination of the comparison reference beam and the comparison test beam;
simultaneously varying said comparison test path to vary the comparison interference and said sample test path to vary the sample interference, wherein said test path comprises at least two variable-length segments, such that varying said test path comprises varying all of said at least two variable-length segments, and such that varying said sample test path causes a variation in all of said variable-length segments of said comparison test path, such that the variation of said sample test path causes a variation of said comparison test path greater in magnitude than the variation of said sample test path; and
determining a wavelength of the sample beam from the sample interference, the comparison interference, and said known wavelength of the comparison beam.

19. An interferometer, comprising:
a beam splitter;
at least one test path reflector;
a fixed reflector mount;
a movable reflector mount with at least one of said at least one test path reflector disposed thereon and movable therewith;
a reference return reflector;
a test return reflector disposed on one of said fixed reflector mount and said movable reflector mount; and
a sensor;
wherein said beam splitter, said at least one test path reflector, said test return reflector, and said reference return reflector are in communication such that:
a beam incident upon said beam splitter is split into a reference beam and a test beam, the reference beam being directed to said reference return reflector and the test beam being directed to said test return reflector via said at least one test path reflector;
the test beam incident upon said test return reflector is reflected as a test return beam directed to said beam splitter via said at least one test path reflector;
the test return beam incident upon said beam splitter is split into a test sensor beam and a test diverted beam, the test sensor beam being directed to said sensor;
the reference beam incident upon said reference return reflector is reflected as a reference return beam directed to said beam splitter; and
the reference return beam incident upon said beam splitter is split into a reference sensor beam and a reference diverted beam, the reference sensor beam being directed to said sensor;
wherein said sensor is adapted to detect an interference of the test sensor beam and the reference sensor beam incident thereon; and
wherein a displacement of said movable reflector mount changes an optical path between said beam splitter and said test return reflector by 2*N*d, d being the displacement and N the number of said test path reflectors plus 1.

20. An interferometer according to claim 19,
wherein an intensity of the interference of the test beam and reference beam incident on said sensor corresponds to
$$I = {I}_{0} [ 1 + cos ( \frac{2 N π d}{λ} ) ]$$
I being the intensity of the interference after moving said movable reflector mount;
Iₒ being the intensity of the interference before moving said movable reflector mount;
N being the number of said test path reflectors plus 1;
d being the displacement of said moveable reflector mount; and
λ being a wavelength of the beam.

20. An interferometer according to claim 19,
wherein said at least one test path reflectors comprises a prism.

21. An interferometer according to claim 19,
wherein said at least one test path reflectors comprises a mirror.

22. A method of interferometry, comprising the steps of:
splitting a beam incident on a beam splitter into a reference beam and a test beam, directing the reference beam to a reference return reflector, and directing the test beam to a test return reflector via at least one test path reflector;
directing the test beam incident upon said test return reflector as a test return beam to said beam splitter via said at least one test path reflector;
splitting the test return beam incident upon said beam splitter into a test sensor beam and a test diverted beam, and directing the test sensor beam to a sensor;
directing the reference beam incident upon said reference return reflector as a reference return beam incident to said beam splitter;
splitting the reference return beam incident upon said beam splitter into a reference sensor beam and a reference diverted beam, and directing the reference sensor beam to said sensor;
moving at least one of said at least one test path reflector such that a displacement thereof changes an optical path between said beam splitter and said test return reflector by 2*N*d, d being the displacement and N the number of test path reflectors plus 1;
detecting with said sensor an interference of the test sensor beam and the reference sensor beam incident on said sensor.

23. A spectrometer, comprising:
a sample interferometer, said sample interferometer comprising
a sample beam splitter;
a movable reflector mount;
a sample reference return reflector;
a sample test return reflector disposed on said movable mount;
a sample beam splitter;
a sample sensor;
wherein said sample beam splitter, said comparison test return reflector, and said comparison reference return reflector are in communication such that:
a sample beam incident upon said sample beam splitter is split into a sample reference beam and a sample test beam, the sample reference beam being directed to said sample reference return reflector and the comparison test beam being directed to said first sample test return reflector;
the sample test beam incident upon said sample test return reflector is reflected as a sample test return beam directed to sample beam splitter;
the sample test return beam incident upon said sample beam splitter is split into a sample test sensor beam and a sample test diverted beam, the sample test sensor beam being directed to said sample sensor;
the sample reference beam incident upon said sample reference return reflector is reflected as a sample reference return beam directed to said sample beam splitter;
the sample reference return beam incident upon said sample beam splitter is split into a sample reference sensor beam and a sample reference diverted beam, the sample reference sensor beam being directed to said sample sensor; and
wherein said sample sensor is adapted to detect an interference of the sample test sensor beam and the sample reference sensor beam incident thereon;
said spectrometer further comprising a comparison spectrometer, said comparison spectrometer comprising
a comparison beam splitter;
at least one comparison test path reflector, at least one of said at least one comparison test path reflector being disposed on said movable reflector mount;
a fixed comparison reflector mount;
a comparison reference return reflector;
a comparison test return reflector disposed on one of said fixed comparison reflector mount and said movable reflector mount;
a comparison sensor;
wherein said comparison beam splitter, said at least one comparison test path reflector, said comparison test return reflector, and said comparison reference return reflector are in communication such that:
a comparison beam incident upon said comparison beam splitter is split into a comparison reference beam and a comparison test beam, the comparison reference beam being directed to said comparison reference return reflector and the comparison test beam being directed to said comparison test return reflector via said at least one comparison test path reflector;
the comparison test beam incident upon said comparison test return reflector is reflected as a comparison test return beam directed to comparison beam splitter via said at least one comparison test path reflector;
the comparison test return beam incident upon said comparison beam splitter is split into a comparison test sensor beam and a comparison test diverted beam, the comparison test sensor beam being directed to said comparison sensor;
the comparison reference beam incident upon said comparison reference return reflector is reflected as a comparison reference return beam directed to said comparison beam splitter;
the comparison reference return beam incident upon said comparison beam splitter is split into a comparison reference sensor beam and a comparison reference diverted beam, the comparison reference sensor beam being directed to said comparison sensor; and
wherein said comparison sensor is adapted to detect an interference of the comparison test sensor beam and the comparison reference sensor beam incident thereon;
wherein a displacement of said movable reflector mount changes an optical path between said sample beam splitter and said sample test return reflector by 2*d, d being the displacement, and simultaneously changes an optical path between said comparison beam splitter and said comparison test return reflector by −2*N*d, d being the displacement and N being the number of comparison test path reflectors plus 1.

24. A spectrometer according to claim 23,
wherein said at least one test path reflector comprises a prism.

25. A spectrometer according to claim 23,
wherein said at least one test path reflectors comprises a mirror.

26. A method of spectrometry, comprising the steps of:
splitting a sample beam of a known wavelength incident upon a sample beam splitter into a sample reference beam and a sample test beam, directing the sample reference beam to a sample reference return reflector, and directing the sample test beam to a sample test return reflector;
directing the sample test beam incident upon said sample test return reflector as a sample test return beam to said sample beam splitter;
splitting the sample test return beam incident upon said sample beam splitter into a sample test sensor beam and a sample test diverted beam, and directing the sample test sensor beam to a sample sensor;
directing the sample reference beam incident upon said sample reference return reflector as a sample reference return beam to said sample beam splitter;
splitting the sample reference return beam incident upon said sample beam splitter into a sample reference sensor beam and a sample reference diverted beam, and directing the sample reference sensor beam to said sample sensor;
splitting a comparison beam incident on a comparison beam splitter into a comparison reference beam and a comparison test beam, directing the comparison reference beam to a comparison reference return reflector, and directing the comparison test beam to a comparison test return reflector via at least one comparison test path reflector;
directing the comparison test beam incident upon said comparison test return reflector to said comparison beam splitter via said at least one comparison test path reflector;
splitting the comparison test return beam incident upon said comparison beam splitter into a comparison test sensor beam and a comparison test diverted beam, and directing the comparison test sensor beam to a comparison sensor;
directing the comparison reference beam incident upon said comparison reference return reflector as a comparison reference return beam incident to said comparison beam splitter;
splitting the comparison reference return beam incident upon said comparison beam splitter into a comparison reference sensor beam and a comparison reference diverted beam, and directing the comparison reference sensor beam to said comparison sensor;
moving at least one of said at least one test path reflector such that a displacement thereof changes an optical path between said beam splitter and said test return reflector by 2*N*d, d being the displacement and N being an integer greater than 1;
detecting with said sample sensor a sample interference of the sample test sensor beam and the sample reference sensor beam incident on said sample sensor;
detecting with said comparison sensor a comparison interference of the comparison test sensor beam and the comparison reference sensor beam incident on said comparison sensor;
determining a wavelength of the sample beam from the sample interference, the comparison interference, and the known wavelength of the comparison beam.
